(19) United States
(12) Patent Application Publication
(10) Pub. No.: US 2015/0195695 A1
(43) Pub. Date: Jul. 9, 2015

(54) CALL PROCESSING SYSTEM

(71) Applicant: Ollo Mobile Pty Ltd., Brisbane (AU)

(72) Inventors: Hugh Geiger, Brisbane (AU); Ken Macken, Brisbane (AU)

(21) Appl. No.: 14/390,707

(22) PCT Filed: Apr. 4, 2013
(86) PCT No.: PCT/AU2013/000351

§ 371 Date: Oct. 3, 2014

(30) Foreign Application Priority Data
Apr. 4, 2012 (AU) 2012901376
Apr. 4, 2012 (AU) 2012901823

(51) Int. Cl. H04W 4/22; H04W 4/02; H04M 3/493; H04M 7/00

(52) U.S. Cl. CPC H04W 4/22; H04M 7/009; H04W 4/02; H04M 3/493; H04W 80/10

(57) ABSTRACT

A system for handling call distribution including a platform arranged to receive a caller ID and to place calls to a selected list of nominated recipients based on dial plan rules linked to the caller ID. The invention also relates to a mobile communications device and a method of dispatching calls including receiving a caller ID from a mobile communications device and placing calls to a selected list of nominated recipients based on dial plan rules linked to the caller ID.

### RELATED APPLICATIONS

The application claims priority from Australian Patent Application No. 2012901376, filed 4 Apr. 2012 and entitled “One button controlled personal tracking and emergency mobile device”; and Australian Patent Application No. 2012901823, filed 4 May 2012 and entitled “Remote Phone Book Service for Emergency Devices”, the contents of which are incorporated by reference.

### FIELD OF THE INVENTION

The present invention relates to a call processing system; a call handling process; and a mobile communications device. For example, the invention relates to a communications device and system particularly, but not exclusively, a single button communications device and related call transfer system.

### BACKGROUND OF THE INVENTION

A single button mobile phone device is commonly used as an emergency communications device for the elderly. The device includes a fixed pre-set phone number stored in the device.

The number calls a service provider who then has an operator handle and forward the call at the direction of the device user. The operator may have access to information that includes a list of names and contact numbers previously provided by the user. This information can be updated via a secure website by the user.

In a variation, the user can change the preset number stored in the device, in order to dial an alternative phone number. To change the number, the mobile device is connected to a computer, to allow the relevant parameters in the device's memory to be changed directly. Alternatively, the device may allow a user to input contacts directly through a cumbersome menu interface.

The device may include multiple buttons that allow corresponding multiple numbers to be stored and individually dialed. Alternatively, a single button may still be used and the multiple numbers accessed via a menu. However, more than one button and/or a complex menu navigation process can make the device harder to use for the elderly, those with disabilities, or young children.

In yet another variation, one or more numbers stored in the device may be updated remotely by sending an SMS to the device with an AT (attention) command sting or similar, or by using a proprietary “over the air” update service which delivers the configuration change to the device via a wireless data transmission.

To update or change a number based on the above, the user would need to either be in physical possession of the device and/or have sufficient skill and patience to send an instruction via SMS, or rely on a third party operator to answer the call and physically redirect the call to the updated contact number.

A system using operator assistance is relatively expensive to run due to the operator involvement in the call handling process. A system that utilizes a device that provides the user with direct control over the numbers to be dialed is cheaper to operate, however, the device may be more complicated to use.

In either case, current systems only provide point-to-point communication. Only one contact can be called at any one time. In the case of an operator-assisted call, the operator must call each listed contact individually and wait for them to answer. The operator needs to identify the recipient before transferring to confirm the number is correct. If no one answers, they must then decide what action to take. This process is slow and expensive.

In the other variations described above, if the user initiates a call directly to a stored number, and the desired contact number does not answer or is incorrect, the user must hang up and try an alternate number, if available. This method is slow and potentially life threatening. If the user is suffering from a severe injury or other medical emergency, such as a stroke, or is the subject of physical assault, they may not have time to call multiple numbers. Point to point communication is a cumbersome method of establishing communications in an emergency, particularly when it is not certain who will be available to answer, or if the contact information for any one number is still current and correct.

### OBJECT OF THE INVENTION

The present invention seeks to provide an improved communications system and an easy to use device.

### SUMMARY OF THE INVENTION

In accordance with the present invention, there is provided a call processing system including a session initiation protocol (SIP) service; a digital private branch exchange (PBX); and a database system including computer readable memory having stored thereon a plurality of result sets, said call processing system for performing the steps of
(a) receiving an incoming call from a mobile communications device, said call including a caller identification (Caller ID);
(b) retrieving a result set from the database system that matches said Caller ID, said result set including a plurality of forwarding numbers and one or more dial plan rules; and
(c) forwarding the incoming call to the forwarding numbers in accordance with one of said dial plan rules.

Preferably, the SIP service performs the step of receiving the incoming call and passing the Caller ID to the PBX. The PBX performs the step of retrieving the result set from the database system by performing the step of sending a query to the database system to retrieve the result set that matches the Caller ID. The PBX communicates with the SIP service to forward the incoming call to the forwarding numbers' in accordance with the dial plan rules. The step of forwarding the incoming call is effected substantially simultaneously to all of the forwarding numbers that match the dial plan rules.

In accordance with the present invention, there is also provided a call handling process implemented by a call processing system including a session initiation protocol (SIP) service; a digital private branch exchange (PBX); and a database system including computer readable memory having stored thereon a plurality of result sets, said process including the steps of:
(a) receiving an incoming call from a mobile communications device, said call including a caller identification (Caller ID);
(b) retrieving a result set from the database system that matches said caller ID, said result set including a plurality of forwarding numbers and one or more dial plan rules; and
(c) forwarding the incoming call to the forwarding numbers in accordance with one of said dial plan rules.

Preferably, the SIP service performs the step of receiving the incoming call and passing the Caller ID to the PBX. The PBX performs the step of retrieving the result set from the database system by performing the step of sending a query to the database system to retrieve the result set that matches the Caller ID. The PBX communicates with the SIP service to forward the incoming call to the forwarding numbers in accordance with the dial plan rules. The step of forwarding the incoming call is effected substantially simultaneously to all of the forwarding numbers that match the dial plan rules.

In accordance with the present invention, there is provided a mobile communications device, including:
(a) one or more computer processors;
(b) non-transient computer readable memory including a computer program stored thereon comprising a plurality of instructions for execution by the one or more processors;
(c) apparatus to effect a telephone call to a predetermined telephone number over a telecommunications network; and
(d) a function button to initiate the telephone call to the predetermined number,

wherein, when said function button is actuated, said program performs the steps of:
(i) generating data pack including a caller identification (Caller ID);
(ii) initiating a call to said predetermined telephone number; and
(iii) sending the data pack to a predetermined digital address.

Preferably, the device further includes device location apparatus. The device location apparatus includes a GPS receiver and/or a WiFi transceiver. The step of generating the data pack includes the step of using the device location apparatus to generate data representing a location of the mobile communications device. The data representing the location of the device are geodetic real world co-ordinates. The device also preferably includes a motion sensor for detecting motion of the mobile communications device. The program preferably performs the steps of:
(a) receiving motion detection data from the motion sensor in response to movement of the device;
(b) determining if the motion detection data represents a reportable motion event;
(c) if a reportable motion event is detected, then the program performs the steps of:
   (i) generating data pack including a Caller ID; data representing a location of the device; and data representing a reportable motion event;
   (ii) initiating a call to said predetermined telephone number; and
   (iii) sending the data pack to the predetermined digital address.

In accordance with the invention, there is provided a system for handling call distribution including a platform arranged to receive a caller ID and to place calls to a selected list of nominated recipients based on dial plan rules linked to the caller ID.

Preferably, the platform is adapted to automatically place multiple simultaneous calls to the list of nominated recipients.

Preferably, the platform includes a database with dial plan rules and the list of nominated recipients, the database being accessible via a web portal to enable updates or modifications to be made to the list.

Preferably, the platform includes a bridge adapted to retrieve the list from the database and patch a caller through to the list of nominated recipients, the bridge connecting the caller to the first recipient to respond.

Preferably, the system includes a single button communications device, the button acting as a call button to initiate a call between the device and the platform.

Preferably, the system stores the dial plan rules and the list of nominated recipients, which form part of a data set associated with the caller ID, the data set including values relating to the use of the device that, if satisfied, trigger actions additional to the placing of calls to the selected list of nominated recipients.

Preferably, the data set includes values relating to one or more of the time of day a call is initiated, a geodetic real world co-ordinate representing a location of the device or a predefined reportable movement threshold of the device, indicating a fall or lack of movement, wherein the system contacts an emergency service when one or more of the values are satisfied.

Preferably, the system allows for voice-based instruction to initiate a call once the call button is pressed.

In accordance with the Invention, there is further provided a method of dispatching calls including receiving a caller ID from a mobile communications device and placing calls to a selected list of nominated recipients based on dial plan rules linked to the caller ID.

Preferably, the calls are placed simultaneously.

Preferably, wherein the dial plan rules and the list of nominated recipients are updated or modified via a web portal.

Preferably, the method includes connecting the caller to the first recipient to respond.

Preferably, the caller ID is received following a call button on a single button mobile communications device being pressed.

Preferably, the method includes storing the dial plan rules and the list of nominated recipients as part of a data set associated with the caller ID, the data set including values relating to the use of the device that, if satisfied, trigger actions additional to the placing of calls to the selected list of nominated recipients.

Preferably, the method includes contacting an emergency service when one or more of the values are satisfied.

Preferably, the method includes sending voice prompts to the device after the call button is pressed, and acting on voice-based instruction from the device in order to initiate a call.

In accordance, with the invention, there is also provided a mobile communications device for use in the above described system and method, the device including a single button for initiating a call, a speaker, a microphone, a GPS receiver, a WIFE transceiver and a motion sensor.

### BRIEF DESCRIPTION OF THE DRAWINGS

The invention is described in more detail, by way of non-limiting example only, with reference to the following drawings, in which:

FIG. 1 is a schematic diagram of a mobile communications device;

FIG. 2 is a diagrammatic representation of a call processing system;

FIG. 3 is a flow diagram of a call being handled by the call processing system;

FIG. 4 is a web portal update flow diagram;

FIG. 5 is a database diagram;

FIG. 6 is a flow diagram illustrating call handling using voice commands;

FIG. 7 is a flow diagram illustrating call handling using motion to trigger a call connection;

FIG. 8 is a data model used to create a data set associated with a called ID;

FIG. 9 is a diagrammatic representation of an alternative call processing system; and

FIG. 10 is a diagrammatic representation of an again alternative call processing system.

### DETAILED DESCRIPTION OF THE INVENTION

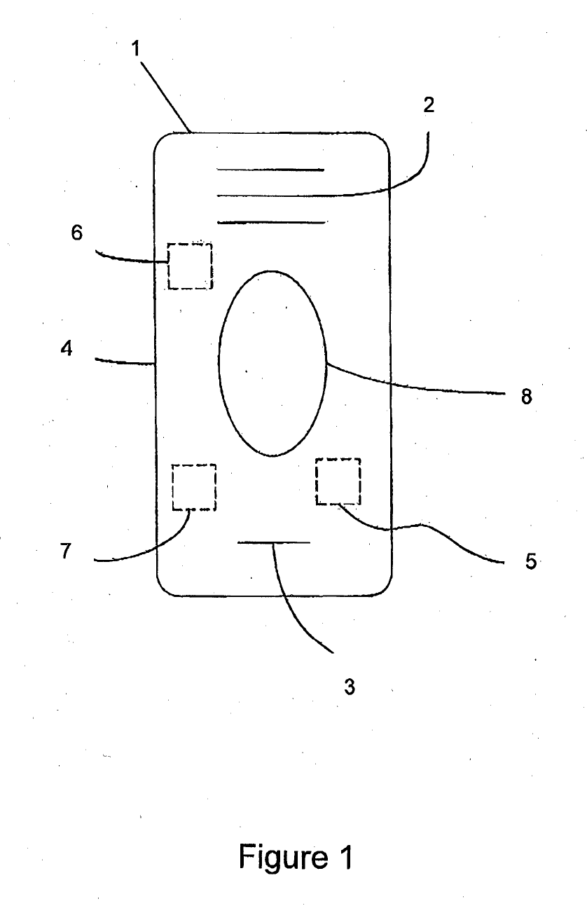

Referring firstly to FIG. 1, a simplified schematic drawing of a mobile communications device 1 is shown. The device 1 includes a speaker 2, microphone 3 and a housing 4 for the various additional phone components such as a device memory 5 and a button 8. The device 1 is preferably a mobile computer device such as a smart phone including an application program, stored thereon in computer readable memory, that is capable of performing the steps described below in further detail.

The button 8 is used in place of an alphanumeric keypad input or equivalent to initiate outgoing calls and/or receive incoming calls. The button 8 is used to dial a pre-set phone number stored in the device memory 5.

The function button 8 is preferably a physical button on the device 1 that is actuated when it is depressed. In an alternative embodiment, the device 1 includes a touch screen (not shown) and the function button 8 is generated as an executable function button on the touch screen and is actuated when the image of the button 8 is pressed by the user.

The device 1 also includes device location apparatus 6 including a WiFi transceiver and GPS receiver, which are used to generate data representing a location of the device location. This information is sent to a remote server having a predetermined digital address via the cellular data network. The device 1 also includes motion sensor, such as a gyroscope, accelerometer and/or similar conventional electronic motion sensor, indicated by reference numeral 7. Other components of the device 1 are omitted for clarity.

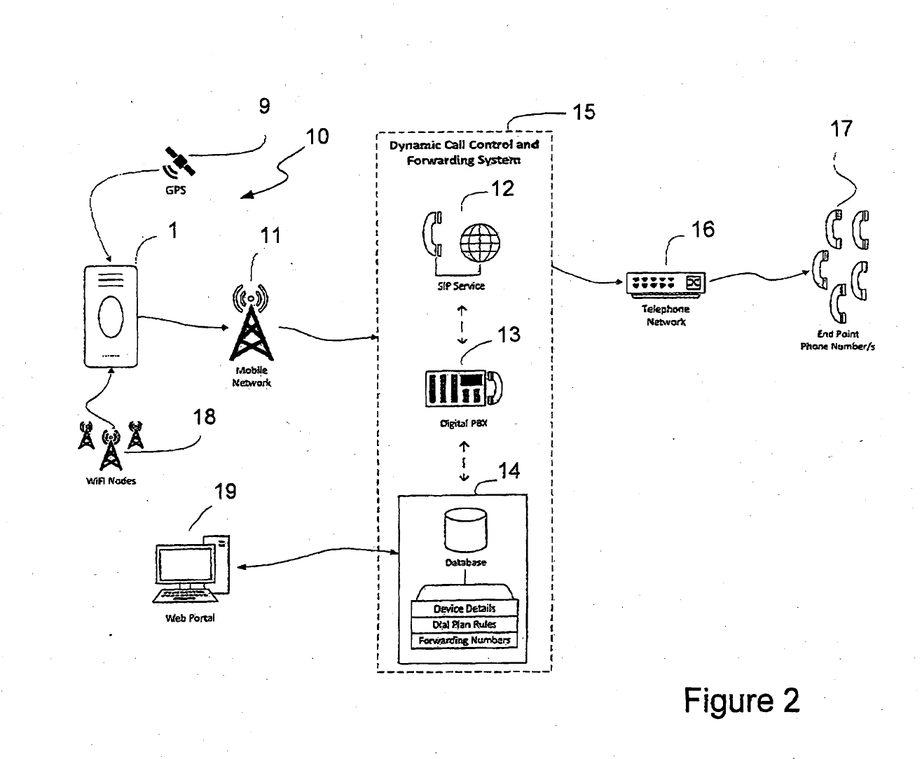

With reference now to FIG. 2, the mobile phone device 1 connects via a cellular network 10 and a cell tower 11 to a dynamic call processing system 15 when an outgoing phone call is made from the device 1. At the same time as the outgoing call the device 1 sends a data packet to the predetermined digital address that includes location data generated from Global Positioning Satellites (GPS) 8, the cell tower 11 and visible WiFi Nodes 18 over the cellular data network 10, which is captured and logged against the device ID in database system 24. The methods and processes for generating this information is generally known in the art and is not described here in further detail.

The call processing system 15 is made up of a Session Initiation Protocol (SIP) service 12 that provides the avenue for incoming and outgoing phone calls, a digital PBX 13 that handles the SIP service 12 connections, execution of dial plan rules and also execution of database queries against a database system 14. The database system 14 contains records associated with a number of specialized mobile phone devices 1 and dial plan rules and forwarding phone numbers for a list of recipients associated with each mobile phone device 1. The dynamic call processing system 15 makes outbound calls through the SIP service 12. The outbound calls from the SIP service 12 are directed to the relevant telephone network 16 for each end point phone number/s 17. The SIP service 12 has multiple lines, and in conjunction with the Digital PBX 13 is able to make multiple outgoing calls simultaneously for each call received from the device 1, and is able to establish multiple simultaneous call connections at the recipient or end point phone numbers 17. In this way, one incoming call from device 1 can result in outgoing calls to a multiple number of end point phone numbers 17.

The database system 14 can be accessed via a web portal 19. The database system 14, which is accessed by the Digital PBX 13 is able to be updated or modified by users from the web portal 19 and allows for changes to the data stored in the database system to be made remotely via the Internet.

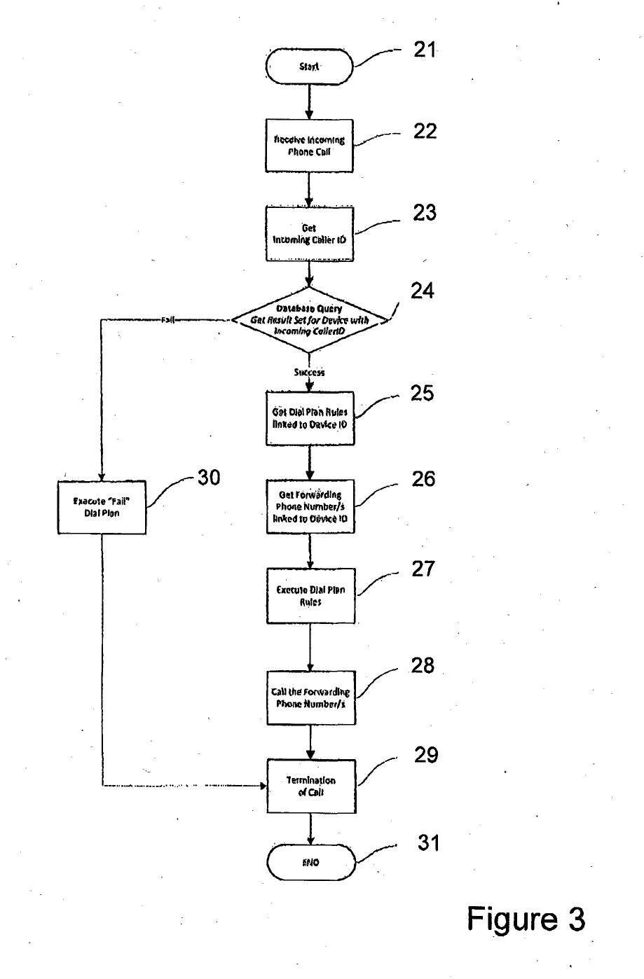

Referring now to FIG. 3, a flow diagram illustrating a process 20 by which the system 15 processes incoming calls is shown. The process 20 commences at the start 21, when an incoming call is received at step 22 by the dynamic call processing system 15. At step 23, the incoming caller ID is retrieved and used to perform a database query 24 against the database system 14. The database query 24 returns a result set on completion of the query.

If the result set returns a fail, the call is processed through a pre-set fail dial plan 30 and then terminated at step 29 on completion. If the result set returned is successful, the dial plan rules are retrieved at step 25 and the forwarding phone number/s are retrieved at step 26, allowing the system to execute the dial plan rules at step 27. The forwarding phone number/s are called at step 28 based on the dial plan rules being executed. On termination of the call 39 either from the incoming phone call ending or an end point number 17 being connected, the process flow ends at step 31.

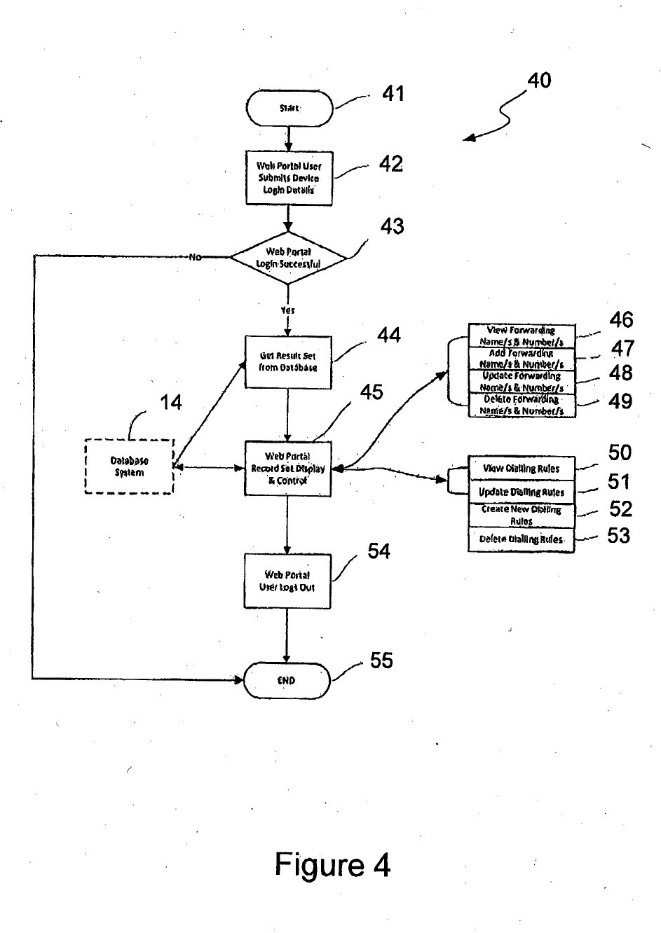

FIG. 4 illustrates a process 40 for accessing the records in the database system 14 via the web portal 19. The process starts at 41 when a user submits login details at step 42, through the web portal 19, to access the record set of a device that is stored in the database system 14. If the web portal login is successful, as defined at step 43, the result set from the database is retrieved at step 44 and is displayed to the user via the web portal at step 45.

The web portal record set display and control interface allows the user to view forwarding names and associated number/s 46, add forwarding names and associated number/s 47, update forwarding names and associated number/s at 48 and delete forwarding names and associated number/s 49, that are associated with the device they have access to through successful the web portal login step 43.

The user can also view dialing rules 50, update dialing rules 51 create new dialing rules 52 and delete existing dialing rules 53 associated with the device through the web portal record set display and control interface.

Any changes made to the record set and saved by the web portal user via the web portal record set display and control interface are updated on the database system 14. When the user logs out of the web portal at step 54, the process flow ends at 55.

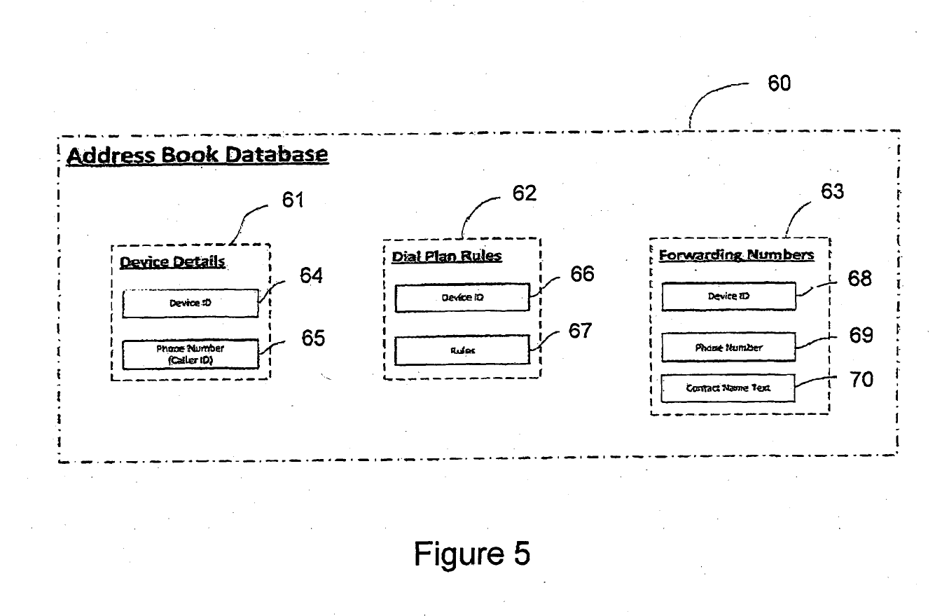

With reference to FIG. 5, the address book database 60 that resides within the database system 14 is made up of three key database tables 61, 62 and 63.

The device details table 61 contains the minimum fields of device ID 64 (a form of Caller ID) and phone number 65 that are directly associated to a specialized mobile phone device 1.

The dial plan rules table 62 contains the minimum fields of device ID 66 and rules 67. The forwarding numbers table 63 contains the minimum Fields of device ID 68, phone number 69 and contact name text 70. The device details table 61 is joined to the dial plan rules table 62 and forwarding numbers table 63 by the unique key field device ID 64, 66 and 68.

The dial plan rules for a Caller ID include values relating to one or more of the following:
(a) a time of day, date, or predefined combination of time and date, that the incoming call is received;
(b) a location of the mobile communications device; and
(c) a reportable motion detection event.

For example, the reportable motion event may be that no motion is detected for a period of 60 minutes, or any other user defined period of time of interest. Alternatively, a reportable motion event may be detection of acceleration equivalent to that of a person falling from a standing position to a floor or ground surface.

Forwarding numbers are associated with values associated with each one of these. For example, a first set of forwarding numbers are associated with a time range of 9:00 AM and 6:00 PM; and a second set of forwarding numbers are associated with a time range of 6:01 PM to 8:59 AM. Similarly, a fourth set of forwarding numbers are associated with a first geographical location (referenced by way of geodetic real world coordinates or WiFi node information) such as a house where the person lives; and a fifth set of forwarding numbers are associated with a second geographical location (referenced by way of geodetic real world coordinates or WiFi node information) such as an office where the person works.

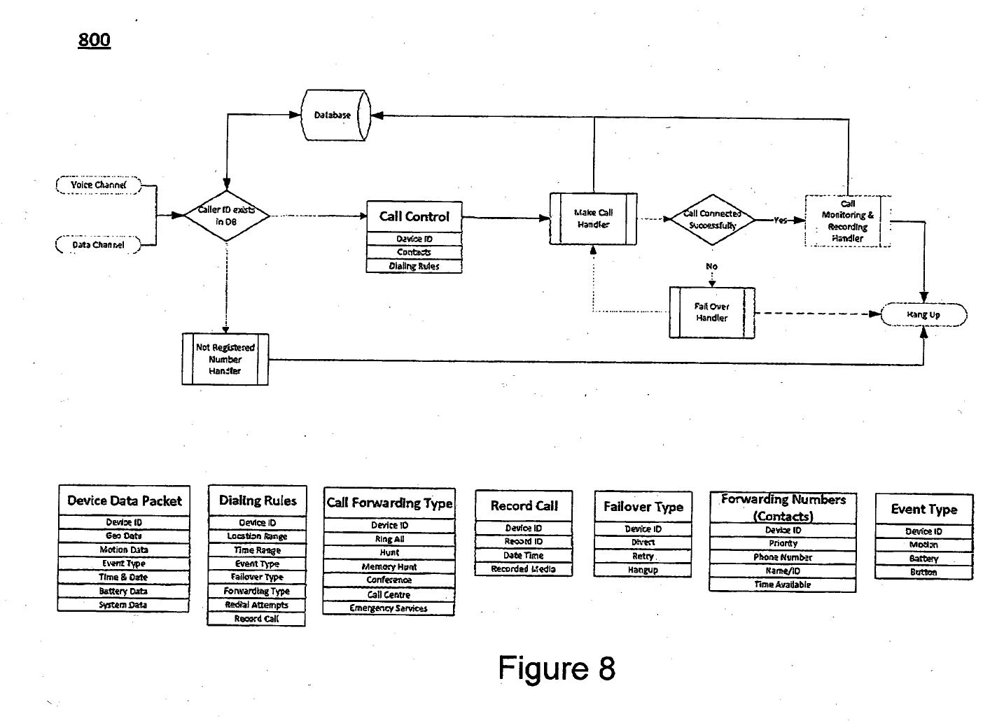

The data model 800 shown in FIG. 8 is used to create a data set associated with a called ID.

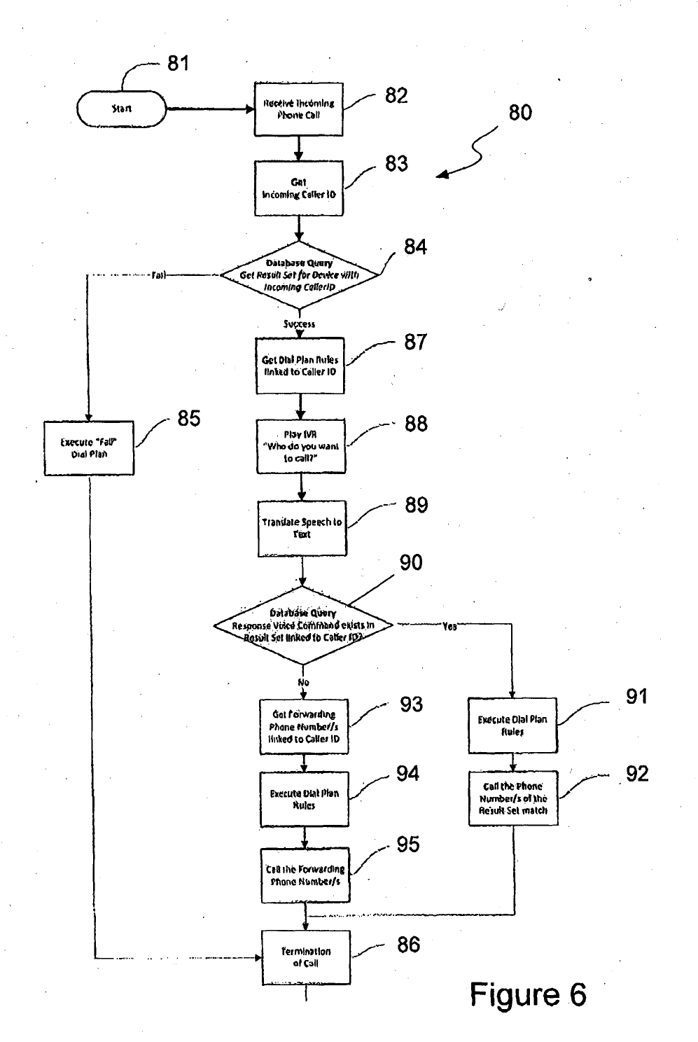

FIG. 6 illustrates an alternative embodiment considered for this invention. The process 80 starts at step 81, when an Incoming call is received at step 82 by the call processing system 15, the incoming caller ID is retrieved at step 83 and used to perform a database query at 84, against the database system 14. The database query 14 returns a result set on completion of the query.

If the result set returns a fail, the call is processed through the fail dial plan at step 85 and then terminated at step 86 on completion. If the result set returned is successful, digital PBX 13 plays an interactive voice recording (IVR) at 88, which is heard through the speaker 2 on the device 1. The user is then required to speak into the device 1 and this audio is captured and passed to a third party speech to text translation service at step 89 and the returned text is used to query the database 14.

If the query is successful the associated dial plan rules are executed at step 91 and the forwarding phone number/s 79 are retrieved and called at step 92, based on the dialing plan rules 62.

If the speech to text query is not successful, the system reverts to using caller ID identification to retrieve forwarding numbers at step 93 allowing the system to execute the dial plan rules at step 94. The forwarding phone number/s are called at step 95 based on the dial plan rules being executed. On termination of the call at step 86 either from the incoming phone call to the system 15 finishing or an end point number 17 being successfully completed, the process flow ends at step 86.

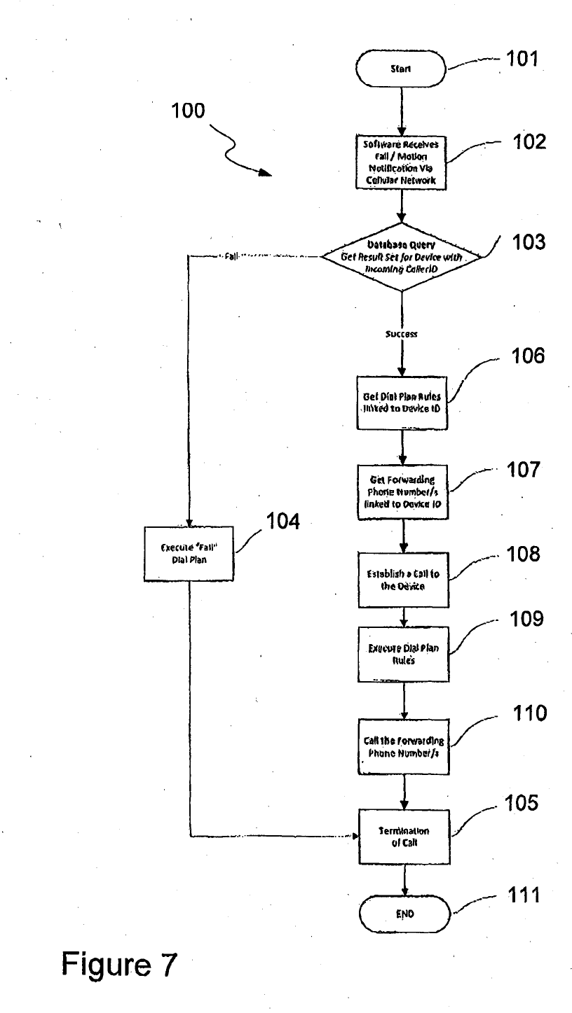

FIG. 7 illustrates a process 100 by which specific motion of the device 1 triggers a response from the call forwarding system 15. The process starts at step 101, when electronic sensors 7 of the device 1 detect an event in the form of a pre-defined motion of the device 1. A data packet with a simple alert that includes the event details and device ID is sent over the cellular data network 10 and received by the system 15 at step 102, the incoming caller ID contained in the data packet is used to perform a database query at step 103 against the database system 14. The database query returns a result set on completion of the query.

If the result set returns a fail, the call is processed through the fail dial plan 104 and then terminated at step 105 on completion. If the result set returned is successful, the dial plan rules and the forwarding phone number/s are retrieved at steps 106 and 107. The PABX system 13 then establishes an outgoing call to the device 1 at step 108. Then the system 15 executes the dial plan rules at step 109. The forwarding phone number/s are called at step 110 based on the dial plan rules being executed. On termination of the call at step 105, either from the incoming phone call finishing or an end point number 17 being reached, the process ends at step 111.

As may be appreciated from the above, the present invention provides a method and system for the automatic control of call forwarding through a remote call handling system in the form of a digital telephony service. The system is specifically for use with specialized mobile phone devices 1 with no alphanumeric keypad input control.

When an incoming call is received at the system 15 described, the incoming phone number is used to retrieve dialing rules and phone numbers to forward the call after a caller ID has been validated in the systems database. The system executes the dialing rules and forwards the incoming call to the phone numbers returned from the database query results. The dialing rules and forwarding phone numbers stored in the database are able to be modified for each individual incoming phone number at any time via a web portal interface and/or suitable application program interface (API).

The system thereby determines how outbound phone calls from the mobile phone devices are controlled and forwarded by an Internet based service platform. More particularly, the invention relates to a method of dynamically controlling how a call is processed and forwarded in an automated digital telephony system based on information stored in a remote database, and associated to the incoming phone number.

Prior art call forwarding systems may not allow such specialized mobile phone devices to call multiple pre-set outgoing phone number/s which have been configured independently of the physical device, and none have an automated call forwarding service that dynamically controls the dialing plan, as described in the present invention.

The invention allows for low cost delivery of a call connection service, without the need for the expense of a human operator. In an emergency, the system can establish an outgoing call to multiple numbers more quickly than conventional systems. It offers the same oversight and redundancy as provided by a human operator, as the system can automatically divert a call to an emergency service or a human operator if none of the nominated contacts answer. The invention performs faster in an emergency than systems where calls are made sequentially and in a point-to-point manner.

The system also provides flexibility for ease of updating or modifying call numbers or dialing rules. At anytime, an authorized user can log in to the web portal or smart phone application, and input contact information or set dialing rules. For example, if a user wants to change or delete a personal contact number normally called when the device makes an outgoing call, a user can access the web portal for that device and delete the particular phone number from the call forwarding dialing list. The web portal also allows the user to add new phone numbers and or modify the current phone numbers in the call forwarding list for that device. This allows for a user to modify the phone numbers the device is connected to when an outgoing call is made without making any changes to the settings stored in the memory of the device.

Processes described and shown in the accompanying drawings are intended to be illustrative of steps performed by one or more computer processors that execute instructions of a computer program stored in non-transient computer memory. As such, a reference to a process step, is to be taken as a reference to a computer implemented method step, and/or a step of a computer program.

Throughout this specification a reference to the term “caller identification” (also referred to as “Caller ID”) is intended to be a generic reference to a unique identifier associated with an incoming call from a mobile communications device 1 to the call processing system 15. For example, the Caller ID may be a unique identifier associated with the device 1, such as a device ID. Alternatively, the Caller ID may be a unique identifier associated with the user.

In an alternative embodiment, the dynamic call control and forwarding system (also referred to as the call processing system) 15 is implemented without the SIP service 12 and PBX 13. The following alternate configurations for connecting and routing the call based on the dialing rules can be implemented in that regard:

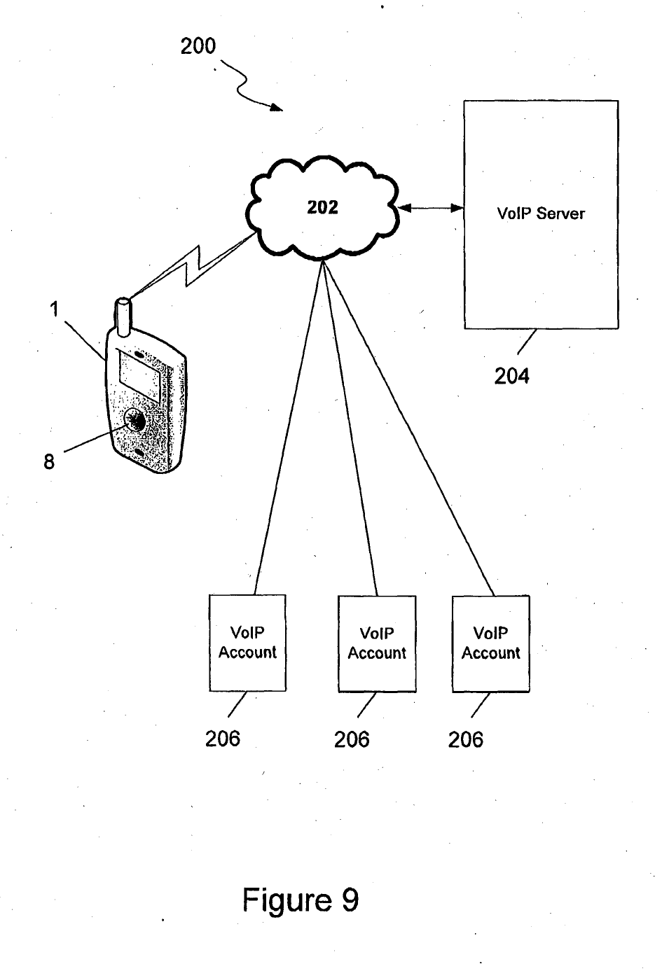

1. VoIP Only 200
With reference to FIG. 9, in this configuration, the device 1 establishes a VoIP session over the network 202 with a VoIP server 204 instead of the SIP/PABX based call processing system 15. The VoIP server 204 is dynamically configured to implement the dialing rules associated with the Caller ID in the same way as described above, and connects the call to other VoIP account addresses 206 instead of phone numbers.

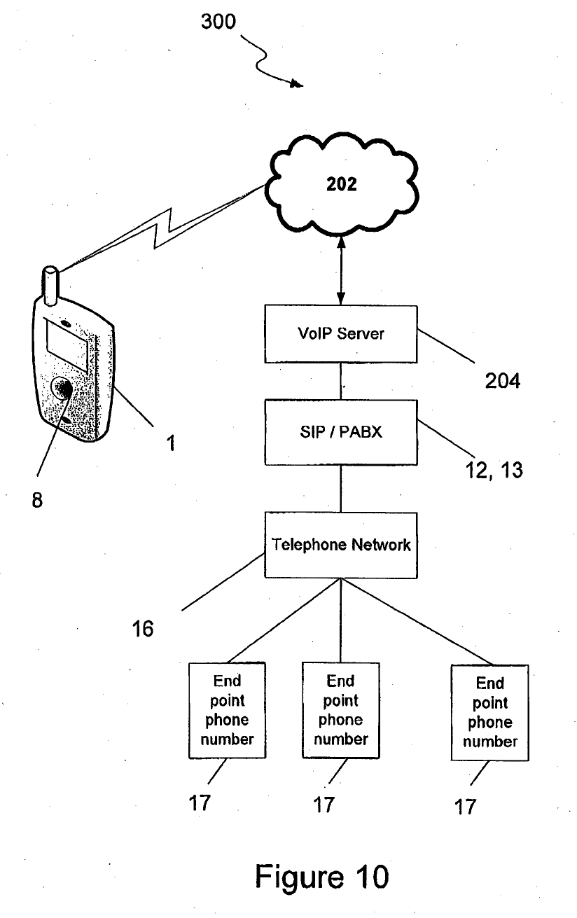

2. VoIP to SIP/PABX 300
With reference to FIG. 10, the device 1 establishes a VoIP session with a VoIP server 204 over the network 202. The SIP/PABX 12, 13 dials and connects the VoIP call to end point phone numbers 17 based on the same dialing rules that are associated with the Caller ID over the telephone network 16.

3. SIP/PABX to VoIP
The device 1 dials the SIP/PABX 12, 13 and the call is connected to one or more VoIP accounts based on the same dialing rules that are associated with the Caller ID.

In process terms, the above three described alternate configurations of the system 15 all achieve the same result as the above described SIP service 12 and PBX 13 combination. However, the use of VoIP is a little different from using PSTN.

The SIP Service 12/Digital PABX configuration 13 is functionally equivalent to a VoIP server that has been configured to handle and route VoIP calls to other nominated VoIP accounts.

### REFERENCE NUMBERS

1. Device
2. Speaker
3. Microphone
4. Housing
5. Memory
6. Receiver
7. Sensor
8. Button
9. Global Positioning Satellite
10. Mobile network
11. Cell tower
12. SIP Service
13. Digital PBX
14. Database system
15. Call processing system
16. Telephone network
17. Phone number
18. Nodes
19. Web portal
20. Process
21. Start
22. Receive incoming call
23. Retrieve caller ID
24. Database query
25. Retrieve dial plan rules
26. Retrieve phone number
27. Execute dial plan rules
28. Call Numbers
29. Terminate call
30. Execute “fail” dial plan
31. End
40. Process
41. Start
42. Web portal login details
43. Web portal login
44. Retrieve data set
45. Portal Interface
46. View names and numbers
47. Add names and numbers
48. Update names and numbers
49. Delete names and numbers
50. View dialing rules
51. Update dialing rules
52. Create new dialing rules
53. Delete dialing rules
54. Web portal log out
55. End
60. Address book database
61. Device details database
62. Dial plan database
63. Forwarding numbers database
64. Device ID
65. Phone number
66. Device ID
67. Rules
68. Device ID
69. Phone number
70. Contact name text
80. Process
81. Start
82. Receive incoming call
83. Retrieve incoming caller ID
84. Database query
85. Execute “fail” dial plan
86. Termination of call
87. Retrieve dial plan rules
88. Play IVR
89. Translate speech to text
90. Database query
91. Execute dial plan rules
92. Call phone number
93. Retrieve forwarding number
94. Execute dial plan rules
95. Call forwarding number
100. Process
101. Start
102. Detection of motion data-packet
103. Database query
104. Execute “fail” dial plan
105. Termination of call
106. Retrieve dial plan rules
107. Retrieve forwarding number
108. Establish call to device
109. Execute dial plan rules
110. Call forwarding number
111. End
200. Call processing system
202. Network
204. VoIP server
206. VoIP account
300. Call processing system

1. A call processing system including a session initiation protocol (SIP) service;
a digital private branch exchange (PBX); and a database system including computer readable memory having stored thereon a plurality of result sets, said calf processing system for performing the steps of:
(a) receiving an incoming call from a mobile communications device, said call including a caller identification (Caller ID);
(b) retrieving a result set from the database system that matches said Caller ID, said result set including a plurality of forwarding numbers and one or more dial plan rules; and
(c) forwarding the incoming call to the forwarding numbers in accordance with one of said dial plan rules.

2. The system claimed in claim 1, wherein the SIP service performs the step of receiving the Incoming call and passing the Caller ID to the PBX.

3. The system claimed in claim 1 or claim 2, wherein the PBX performs the step of retrieving the result set from the database system by performing the step of sending a query to the database system to retrieve the result set that matches the Caller ID.

4. The system claimed in any one of claims 1 to 3, wherein the PBX communicates with the SIP service to forward the Incoming call to the forwarding numbers in accordance with the dial plan rules.

5. The system claimed in any one of claims 1 to 4, wherein the step of forwarding the incoming call is effected substantially simultaneously to all of the forwarding numbers that match the dial plan rules.

6. The system claimed in any one of claims 1 to 5, wherein the PBX is adapted connect the caller to a first forwarding number to respond to the incoming call.

7. The system claimed in any one of claims 1 to 6, wherein the dial plan rules for a Caller ID include values relating to a time of day that the incoming call is received.

8. The system claimed in any one of claims 1 to 5, wherein the PBX is adapted to connect the caller to multiple forwarding numbers simultaneously by way of initiating a teleconference call to said forwarding numbers.

9. The system claimed in any one of claims 1 to 8, said system being adapted to perform the step of receiving, associated with the incoming call, data representing a location of the mobile communications device.

10. The system claimed in claim 9, wherein the data representing the location is a geodetic real world co-ordinate.

11. The system claimed in claim 9 or claim 10, wherein the dial plan rules for a Caller XD include values relating to the location of the mobile communications device.

12. The system claimed in any one of claims 1 to 11, said system being adapted to perform the step of receiving, associated with the incoming call, data representing a reportable motion detection event.

13. The system claimed in claim 12, wherein the dial plan rules for a Caller ID include values relating to a reportable motion detection event.

14. The system claimed in claim 13, wherein the reportable motion event is zero movement detected for a prescribed period, or acceleration representing a fall from a standing position.

15. The system claimed in any one of claims 1 to 14, including a web server in communication with the database system, said web server hosting a web portal that facilitates access to result sets stored on the database.

16. The system claimed in claim 15, wherein the web portal is adapted to generate an application program interface (API) that;
(a) receives a user identification (User ID);
(b) retrieves a result set from the database system that matches the User ID; and
(c) displays the forwarding numbers and dial plan rules associated with the User ID.

17. The system claimed in claim 16, wherein the API is adapted to allow a user to create and/or amend forwarding numbers and/or dial plan rules associated with the User ID and updates the database system with any such amendment.

18. The system claimed in any one of claims 1 to 17, being adapted to perform the step of, receiving a voice-based instruction after the incoming call has been received and executing call forwarding in accordance with the voice based instruction.

19. The system claimed in any one of claims 1 to 18, wherein the mobile communications device is a single button communications device, the button acting as a call button to initiate a call between the device and the SIP service.

20. A call handling process implemented by a call processing system including a session initiation protocol (SIP) service; a digital private branch exchange (PBX); and a database system including computer readable memory having stored thereon a plurality of result sets, said process including the steps of;
(a) receiving an incoming call from a mobile communications device, said call including a caller identification (Caller ID);
(b) retrieving a result set from the database system that matches said caller ID, said result set including a plurality of forwarding numbers and one or more dial plan rules; and
(c) forwarding the incoming call to the forwarding numbers in accordance with one of said dial plan rules.

21. The process claimed in claim 20, wherein the SIP service performs the step of receiving the incoming call and passing the Caller ID to the PBX.

22. The process claimed in claim 20 or claim 21, wherein the PBX performs the step of retrieving the result set from the database system by performing the step of sending a query to the database system to retrieve the result set that matches the Caller ID.

23. The process claimed in any one of claims 20 to 22, wherein the PBX communicates with the SIP service to forward the incoming call to the forwarding numbers in accordance with the dial plan rules.

24. The process claimed in any one of claims 20 to 23, wherein the step of forwarding the incoming call is effected substantially simultaneously to all of the forwarding numbers that match the dial plan rules.

25. The process claimed in any one of claims 20 to 24, wherein the PBX is adapted connect the caller to a first forwarding number to respond to the incoming call.

26. The process claimed in any one of claims 20 to 25, wherein the PBX is adapted to connect the caller to multiple forwarding numbers simultaneously by way of initiating a teleconference call to said forwarding numbers.

27. The process claimed in any one of claims 20 to 26, wherein the dial plan rules for a Caller ID include values relating to a time of day that the Incoming call is received.

28. The process claimed in any one of claims 20 to 27, including the step of receiving, associated with the incoming call, data representing a location of the mobile communications device.

29. The process claimed in claim 28, wherein the data representing the location are geodetic real world co-ordinates.

30. The process claimed in claim 28 or claim 29, wherein the dial plan rules for a Caller ID include values relating to the location of the device.

31. The process claimed in any one of claims 20 to 30, including the step of receiving, associated with the incoming call, data representing a reportable motion detection, event.

32. The process claimed in claim 31, wherein the reportable motion event is zero movement detected for a prescribed period, or acceleration representing a fall from a standing position.

33. The process claimed in claim 31 or claim 32, wherein the dial plan rules for a Caller ID include values relating, to a reportable motion detection event.

34. The process claimed in any one of claims 20 to 33, including the step of receiving a voice-based instruction after the incoming call has been received and executing call forwarding in accordance with the voice based instruction.

35. The process claimed in any one of claims 20 to 34, wherein the mobile communications device is a single button communications device, the button acting as a call button to initiate a call between the device and the SIP service.

36. A mobile communications device, including:
(a) one or more computer processors;
(b) non-transient computer readable memory including a computer program stored thereon comprising a plurality of instructions for execution by the one or more processors;
(c) apparatus to effect a telephone call to a predetermined telephone number over a telecommunications network; and
(d) a function button to initiate the telephone call to the predetermined number,
wherein, when said function button is actuated, said program performs the steps of:
(i) generating data pack including a caller identification (Caller ID);
(ii) initiating a call to said predetermined telephone number; and
(iii) sending the data pack to a predetermined digital address.

37. The device claimed in claim 36, further including device location apparatus.

38. The device claimed in claim 37, wherein the device location apparatus includes a GPS receiver and/or a WiFi transceiver.

39. The device claimed in claim 37 or 38, wherein the step of generating the data pack includes the step of using the device location apparatus to generate data representing a location of the mobile communications device.

40. The device claimed in claim 39, wherein the data representing the location of the device are geodetic real world co-ordinates.

41. The device claimed in any one of claims 37 to 40, including a motion sensor for detecting motion of the mobile communications device.

42. The device claimed in claim 37, wherein said program performs the steps of:
(a) receiving motion detection data from the motion sensor in response to movement of the device;
(b) determining if the motion detection data represents a reportable motion event;
(c) if a reportable motion event is detected, then the program performs the steps of:
(i) generating data pack including a Caller ID; data representing a location of the device; and data representing a reportable motion event;
(ii) initiating a call to said predetermined telephone number; and
(iii) sending the data pack to the predetermined digital address.

43. The device claimed in claim 42, wherein the step of determining if the motion detection data represents a reportable motion event includes the step of determining if zero movement has occurred for a predetermined period of time.

44. The device claimed in claim 42 or claim 43, wherein the step of determining if the motion detection data represents a reportable motion event includes the step of determining if an acceleration event has occurred that would represent the user falling from a standing position.

45. The device claimed in any one of claims 36 to 44, wherein the function button is a physical button on the device that is actuated when it is depressed.

46. The device claimed in any one of claims 36 to 44, wherein the device includes a touch screen and the function button is generated as an executable function button on the touch screen and is actuated when the image of the button is pressed by the user.

47. A system for handling call distribution including a platform arranged to receive a caller ID and to place calls to a selected list of nominated recipients based on dial plan rules linked to the caller ID.

48. The system of claim 47, wherein the platform is adapted to automatically place multiple simultaneous calls to the list of nominated recipients.

49. The system claimed in claim 47, wherein the PBX is adapted to connect the caller to multiple forwarding numbers simultaneously by way of initiating a teleconference call to said forwarding numbers.

50. The system of claim 48 or claim 49, wherein the platform includes a database with dial plan rules and the list of nominated recipients, the database being accessible via a web portal to enable updates or modifications to be made to the list.

51. The system of claim 50, wherein the platform includes a bridge adapted to retrieve the list from the database and patch a caller through to the list of nominated recipients, the bridge connecting the caller to the first recipient to respond.

52. The system of any one of claims 47 to 51, further including a single button communications device, the button acting as a call button to initiate a call between the device and the platform.

53. The system of claim 52, wherein the system stores the dial plan rules and the list of nominated recipients, which form part of a data set associated with the caller ID, the data set including values relating to the use of the device that, if satisfied, trigger actions additional to the placing of calls to the selected list of nominated recipients.

54. The system of claim 53, wherein the data set includes values relating to one or more of the time of day a call is initiated, a geodetic real world co-ordinates representing a location of the device or a reportable movement of the device, indicating a fall or lack of movement, wherein the system contacts an emergency service when one, or more of the values are satisfied.

55. The system of claim 54, wherein the system allows for voice-based instruction to initiate a call from a predefined list of contacts once the call button is pressed.

56. A method of dispatching calls including receiving a caller ID from a mobile communications device and placing calls to a selected list of nominated recipients based on dial plan rules linked to the caller ID.

57. The method of claim 56, wherein the calls are placed simultaneously.

58. The method claimed in claim 57, wherein the PBX is adapted to connect the caller to multiple forwarding numbers simultaneously by way of initiating a teleconference call to said forwarding numbers.

59. The method of claim 57 or claim 58, wherein the dial plan rules and the list of nominated recipients are updated or modified via a web portal.

60. The method of any one of claims 56 to 59, further including connecting the caller to a first one of the recipients to respond.

61. The method of any one of claims 56 to 60, wherein the caller ID is received following a call button on a single button mobile communications device being pressed.

62. The method of claims 61, further including storing the dial plan rules and the list of nominated recipients as part of a data set associated with the caller ID, the data set including values relating to the use of the device that, if satisfied, trigger actions additional to the placing of calls to the selected list of nominated recipients.

63. The method of claim 62, wherein the method includes contacting an emergency service when one or more of the values are satisfied.

64. The method of claim 62, further including sending voice prompts to the device after the call button is pressed, and acting on voice-based instruction from the device in order to initiate a call.

65. A mobile communications device for use in the above described system and method, the device including a single button for initiating a call, a speaker, a microphone, a GPS receiver, a WiFi transceiver and a motion sensor.

66. The system claimed in any one of claims 1 to 19 and 47 to 55, wherein the caller ID is a device ID.

67. The process claimed in any one of claims 20 to 35, wherein the caller ID is a device ID.

68. The device claimed in any one of claims 36 to 46 and 55, wherein the caller ID is a device ID.

69. The method claimed in any one of claims 56 to 64, wherein the caller ID is a device ID.
